(19) United States
(12) Patent Application Publication
(10) Pub. No.: US 2002/0022970 A1
(43) Pub. Date: Feb. 21, 2002

(54) Branded channel

(76) Inventors: Roland Noll, Columbia, MD (US); Clinton Wolf, Plano, TX (US)

Correspondence Address: DORSEY & WHITNEY, 1001 PENNSYLVANIA AVE., N.W., SUITE 300 SOUTH, WASHINGTON, DC, 20004, US

(21) Appl. No.: 09/911,794

(22) Filed: Jul. 25, 2001

Related U.S. Application Data
(60) Provisional application No. 60/220,509, filed on Jul. 25, 2000.

(51) Int. Cl. G06F 17/60

(52) U.S. Cl. 705/1

(57) ABSTRACT

A method and system for providing a branded channel that includes branded channel content that is relevant to a brand is disclosed. The branded channel content may include high bandwidth content and is preferably delivered via a communication medium to a client computer, such as a home computer or an interactive kiosk. An embodiment of the method of providing a branded channel preferably includes delivering the branded channel via a communication medium, displaying the branded channel content, whereby the displaying step displays branded channel content with links to other content, the other content including a first progressive marketing opportunity, and displaying the first progressive marketing opportunity. The first progressive marketing opportunity is a marketing opportunity that is related to the displayed branded channel content.

### CROSS REFERENCE TO RELATED APPLICATIONS

This application hereby claims the benefit of the priority of U.S. Provisional Patent Application, Ser. No. 60/220,509, filed Jul. 25, 2000, which is hereby incorporated by reference. This application also hereby incorporates by reference U.S. Patent Application, Ser. No. 09/835,529, entitled “Channel Dancer” and filed Apr. 17, 2001, U.S. Patent Application, Ser. No. 09/878,232, entitled “Personal Content Manager” and filed Jun. 12, 2001, U.S. Patent Application, Ser. No. 09/893,634, entitled “Virtual Multicasting”, and filed Jun. 29, 2001, U.S. Patent Application, Ser. No. 09/893,635, entitled “Digital Rights Management”, and filed Jun. 29, 2001, and U.S. Patent Application, Ser. No. 09/902,764, entitled “Credit System”, and filed Jul. 12, 2001.

### BACKGROUND

1. Technical Field

The present invention is related to theme-oriented content delivery, and more particularly to content delivery devoted to a particular brand.

2. Description of Related Art

Over the past ten years, the bandwidth capacity available to consumers for receiving content from the Internet and other networks has increased ten-fold and more. The increased bandwidth capacity has enabled consumers to download larger and larger files and other content, including rich media and multimedia broadband content such as audio clips, video clips, songs, programs and movies (collectively, content). This increased bandwidth capacity has increased Internet usage and the potential for enjoyable and productive usage.

Despite the increased bandwidth, relatively little creativity has gone into packaging content. Content is delivered by theme-oriented web-sites, such as sports web-sites such as ESPN.com or new web-sites such as ABCNEWS.com. However, content is not delivered under a brand-oriented basis. A brand generally refers to a company's brand name(s), which are generally trademarked, under which the company sells goods or services. A company may have multiple brands. Delivery systems do not deliver content solely focused on a brand and the products or services that are offered by that brand.

Home Depot, Inc. does have an internal Home Depot TV, but this is focused on internal training and human resources. There does not exist a consumer-oriented channel that is devoted to a single brand. As the availability of high bandwidth content has become more prevalent, consumers have demanded more choices and more focus on the consumers' needs and wants. The consumer does not want to waste time finding content devoted to products and services in which the consumer is interested. In today's fast-paced times, the consumer wants to be able to easily and quickly view content, whether at home or at a store, that is devoted to a brand's products and services for which the consumer is shopping. The brands that are able to provide such content will survive and thrive; the brands that do not will not.

### SUMMARY OF THE INVENTION

An advantage of the present invention is that it overcomes the disadvantages of the prior art. Another advantage of the present invention is that it provides consumer-oriented channels that are each devoted to a single brand. Yet another advantage of the present invention is that it provides content related to the products and services offered by a brand. Still another advantage of the present invention is that it enables a brand to provide content, either to consumers at home or at stores, that is devoted to the products and services in which the consumers are interested. An advantage of the present invention is that it provides branded channels available in user homes or at stores.

These and other advantages of the present invention are achieved by a method of providing a branded channel. The branded channel is associated with a brand and the branded channel includes only branded channel content that is relevant or related to the brand. The method comprises the steps of delivering the branded channel via a communication medium, displaying the branded channel content, whereby the displaying step displays branded channel content with links to other content, the other content including a progressive marketing opportunity, and displaying the progressive marketing opportunity. The progressive marketing opportunity is a marketing opportunity that is related to the displayed branded channel content.

These and other advantages of the present invention are also achieved by a branded channel associated with a brand. The branded channel is delivered via a communication medium and includes branded channel content relevant to the brand. The branded channel content is displayed by a client computer on a display device. The branded channel content further includes progressive marketing opportunities. The progressive marketing opportunities are related to the branded channel content, include offers for products or services of the brand, and may be selected by a user of the client computer.

Likewise, these and other advantages of the present invention are achieved by a method of placing avails in a retail outlet's aisle. The method includes the step of delivering a branded channel to a client in a retail outlet. The branded channel includes branded channel content. The method further includes locating the client in an aisle of the retail outlet and displaying the branded channel content on the client in the aisle. The aisle contains related products and the branded channel content includes content relevant to one or more of the related products in the aisle.

Furthermore, these and other advantages of the present invention are achieved by an interactive kiosk. The interactive kiosk includes a display that displays a branded channel, an input device that enables a user to enter data, a broadband connection, that enables the interactive kiosk to receive broadband content, and a processor, that processes instructions to display specific content and to transmit data entered into with the input device. The branded channel comprises branded channel content relevant to products displayed near the interactive kiosk.

Finally, these and other advantages of the present invention are achieved by a method of providing a branded channel. The branded channel is associated with a brand and the branded channel includes only branded channel content that is relevant or related to the brand. The method includes the step of delivering the branded channel via a communication medium to a location in a retail outlet. The branded channel content includes retail aspect content. The method further includes displaying the retail aspect content, wherein the retail aspect content includes moment-in-time marketing opportunities and displaying the moment-in-time marketing opportunities. The moment-in-time marketing opportunities are related to products or services offered for sale at the location in the retail outlet.

### BRIEF DESCRIPTION OF THE DRAWINGS

The detailed description will refer to the following drawings, in which like numbers and letters refer to like items, and in which:

FIG. 1 is a schematic diagram illustrating an exemplary content delivery system that may be used to deliver a branded channel.

FIGS. 2A and 2B are block diagrams illustrating exemplary hardware components that support and enable delivery of a branded channel.

FIG. 3 is a conceptual diagram illustrating an embodiment of a branded channel and aspects of the branded channel.

FIGS. 4A and 4B are conceptual diagrams illustrating embodiments of a consumer aspect of a branded channel and content provided by the consumer aspect of the branded channel.

FIG. 4C is a flowchart illustrating a method of providing consumer aspect content of a branded channel.

FIG. 5A is a conceptual diagram illustrating an embodiment of a retail aspect of a branded channel and content provided by the retail aspect of the branded channel.

FIG. 5B is a flowchart illustrating a method of providing retail aspect content of a branded channel.

FIGS. 6A and 6B are flowcharts illustrating methods of providing consumer aspect and retail aspect content of a branded channel that include credit award offers.

### DETAILED DESCRIPTION OF THE INVENTION

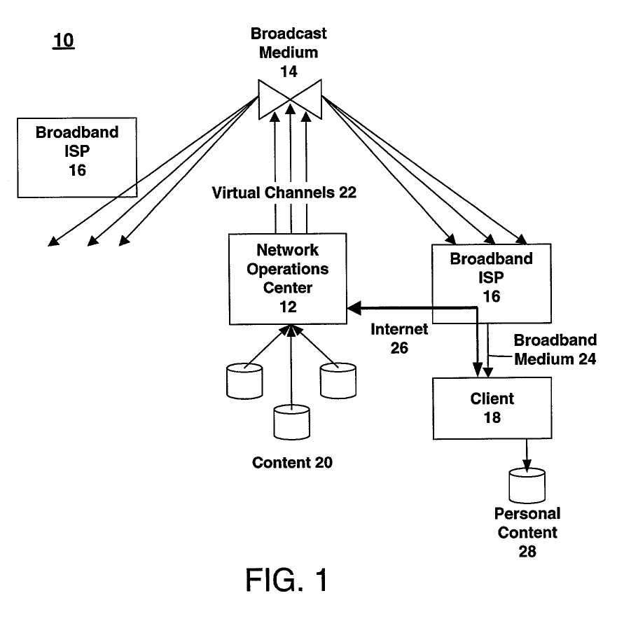

The present invention comprises a credit system and method that provides an online payment system for purchasing of credits and a mechanism for earning credits. The credits, whether purchased or earned, may be used (i.e., on-line as on-line cash) to pay for content (e.g., provided by a broadband content delivery system, such as shown in FIG. 1, an Internet Service Provider (ISP), a direct-to-home content provider, or any other content source). In addition, the credit system enables advertisers or vendors to promote their products or services through permissive marketing by awarding credits to users that view their ads, test their products or purchase their products on-line, among other things.

FIG. 1 illustrates a broadband content delivery system 10 with which the present invention may be used to deliver a branded channel, which includes content that is relevant to a particular brand, to consumer, retailer and enterprise environments. The broadband content delivery system 10 is exemplary and the branded channel of the present invention may be delivered by any content delivery system and delivered in any manner. The illustrative broadband content delivery system 10 comprises a signal origination point 12, a transmission medium 14 (e.g., a satellite or a landline), one or more service providers 16, and one or more clients 18. The client 18 typically includes a user machine (e.g., a PC) that includes resident client software. The client software enables access to the broadband content, supports the broadband content delivery system 10 and delivery of the branded channel. The client 18 that receives a branded channel may be resident in a user's home or at a store that sells products and services of or related to the brand of the branded channel.

Typically, high bandwidth content 20 (e.g., video, audio and web data) is transmitted from a signal origination point 12 such as a Network Operations Center (“NOC”) on high-resolution (“high rez”) virtual channels 22. The branded channels may be delivered as virtual channels 22. The NOC may include one or more servers that support the delivery the virtual channels 22, including the branded channels. The servers preferably multiplex or otherwise combine streams of content 20 onto one or more virtual channels 22. For example, the servers may multiplex streams of branded channel content, e.g., provided by the brand, onto a virtual channel 22 to create a branded channel. The transmission medium 14 is satellite, ether and/or landline, or a combination thereof. The content 20 is received by a service provider 16, typically an edge-of-net broadband Internet service provider (“ISP”) and transmitted over a broadband medium 24, such as a digital subscriber line (“DSL”) or coaxial cable, to a client 18. The broadband medium connection may be maintained or “open” continuously or substantially maintained continuously. Two-way communications between the client 18 and the NOC 12 are maintained over the Internet 26. Content may also be received by the client 18 directly from the Internet 26 via the ISP 16.

In addition to transmitting the content on virtual channels 22, the broadband content delivery system 10 also transmits a control channel (signal) that is received by the client 18. The control channel contains information and instructions that help enable the client 18 (i.e., the client software) to access and control the content 20 provided by the broadband content delivery system 10. The control channel is used to issue commands or directives to the client 18. These commands or directives may result in feedback or a report back from the client 18 to the NOC 12 via the Internet. Significantly, the control channel is used to deliver program descriptors or “program nuggets”, and digital messages.

Not necessarily all clients 18 of the broadband content delivery system 10 will have the bandwidth capability or resources to receive the high bandwidth on high rez virtual channels 22 (e.g., 512 Kbps or more). Accordingly, in addition to high bandwidth content 20, the broadband content delivery system 10 provides low bandwidth content 20 on low-resolution (“low rez”) virtual channels 22 (e.g., approximately 200 Kbps) or other communications bandwidth to accommodate these clients. Consequently, when a client 18 signs-on, the broadband content delivery system 10 preferably conducts a bandwidth test to measure client's 18 bandwidth capability (“available bandwidth”). Usually, the available bandwidth is calculated as the maximum bandwidth content that the client 18 can consistently receive.

Referring back to FIG. 1, content 20, including branded channels, may be transmitted, delivered or broadcast (broadcast, delivered, and transmitted is meant herein to include any method of delivering content, including for example, multicasting, unicasting, direct transmission, or file download) by the NOC 12 on the virtual channels 22 as real-time multicast or unicast streams. A multicast stream comprises streaming content that is directed to and available to multiple clients 18 that join a multicast group. A unicast stream comprises streaming content that is directed to and available to one client 18 at a time; unicast content must be replicated for each client 18 that receives it. Furthermore, additional content 20 may be provided by third-parties as on-demand broadband content selected from the Internet (“edge-of-net”) by a user at the client 18. For example, an ISP 16 may provide the edge-of-net content. Likewise, the user may store selected content, such as portions of the real-time multicast or unicast streams in a local cache at the client 18. This stored or personal content 28 may be kept on a user machine hard-drive or other storage medium.

A company that wants to provide a branded channel may deliver content related to the company's brand to the NOC 12 (or other content delivery origination point) for delivery to clients 18. The company may transmit the branded content via a communication medium to the NOC 12 for preparation and placement on the branded channel. Alternatively, a third-party may prepare the content for the branded channel at the company's request or direction. Likewise, the company may maintain its own NOC and itself deliver the content on a branded channel directly to clients 18, via the Internet, forwarding and storing of content, or other content delivery mechanisms. When displayed by the client 18, the branded channel may be shown with a web browser (see below) and the brand may be prominently displayed in the web browser window. For example, the company's brand may be shown on a border strip or strips along the edge(s) of the web browser window.

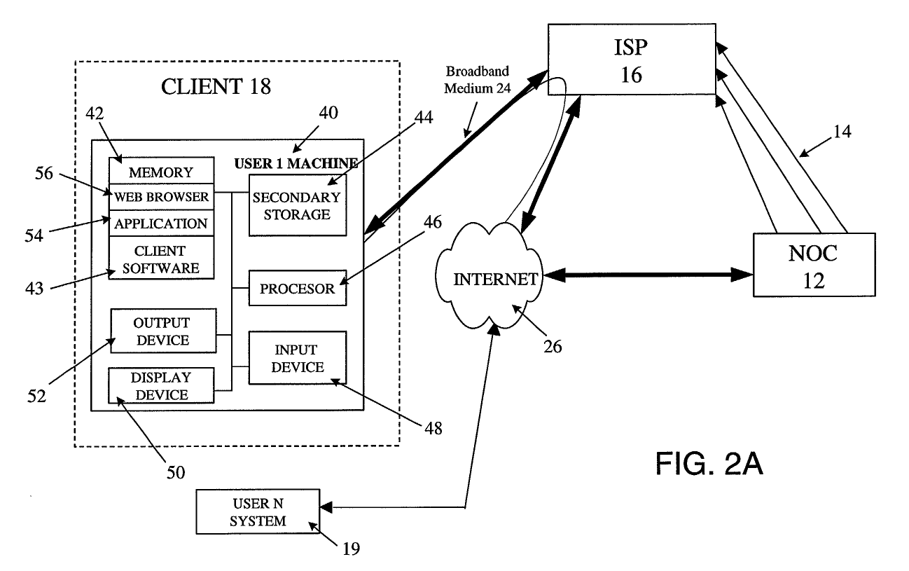

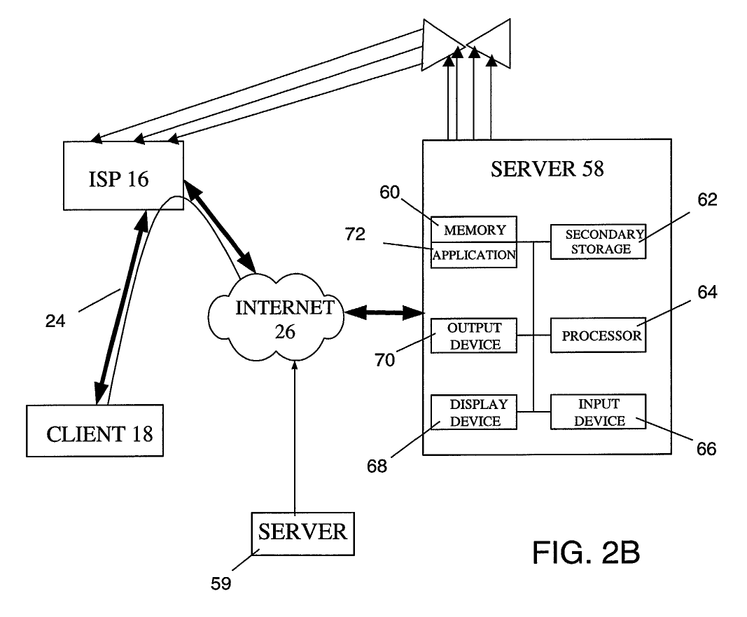

FIGS. 2A and 2B are block diagrams illustrating exemplary hardware components of the exemplary broadband content delivery system 10, or other content delivery system, that may be used for implementing and delivering the branded channel. FIG. 2A includes the client 18, comprising a user machine 40 connected with a network such as the Internet 26, providing network connections to the NOC 12 and the ISP 16 (or other content source). As noted above, the client 18 may be resident in a user's home or at a store that sells products and services of or related to the brand of the branded channel. The user machine 40 includes the client software 43 that the user has downloaded from an ISP 16 or portal or otherwise obtained (e.g., by loading from a CD-ROM or magnetic disk or by being pre-installed on the user machine 40). As mentioned, the client software 43 supports the broadband content delivery system 10 and is preferably executed to receive the branded channel. Other clients 18, such as client 19 may also be connected with network and may include the same components as client 18.

The user machine 40 illustrates typical components of a user machine. The user machine 40 typically includes a memory 42, a secondary storage device 44, a processor 46, an input device 48, a display device 50, and an output device 52. Memory 42 may include random access memory (RAM) or similar types of memory, and it may store one or more applications 44, including client software 43, and a web browser 56, for execution by processor 46. The secondary storage device 44 may include a hard disk drive, floppy disk drive, CD-ROM drive, or other types of non-volatile data storage. The local cache that includes a user's personal content 28, may be stored on the secondary storage device 44.

The processor 46 may execute client software 43 and other applications 44 stored in memory 42, or secondary storage 44, or received from the Internet or other network 26. The processor 46 may execute client software 43 in order to provide some or all of the functions described in this specification. The input device 48 may include any device for entering information into the user machine 40, such as a keyboard, mouse, cursor-control device, touch-screen, infrared sensor, microphone, digital camera, video recorder or camcorder. The display device 50 may include any type of device for presenting visual information such as, for example, a computer monitor or flat-screen display. The output device 52 may include any type of device for presenting a hard copy of information, such as a printer, and other types of output devices include speakers or any device for providing information in audio form.

The web browser 56 is used to access the client software 43 and display interface screens through which the user can view content, including the branded channel, delivered by the broadband content delivery system 10 or otherwise obtained from any content source. The web browser 56 also is used to access the NOC 12, the ISP 16, and third-party websites that include other content (e.g., digital music and video files). Examples of web browsers 56 include the Netscape Navigator program and the Microsoft Internet Explorer program. The content broadcast on virtual channels and received by the client 18 may be displayed through the web-browser 56. The content may include “links”, for example, HyperText Transport Protocol (“HTTP”) hyperlinks to other content and/or Internet websites. Multimedia applications such as Microsoft Media Player™ and RealPlayer™ may be used to enable viewing of the real-time multicast stream. Any web browser, co-browser, or other application capable of retrieving content from a network (any wireline or wireless network may be used) and displaying pages or screens may be used.

Examples of user machines 40 for interacting within the broadband content delivery system 10 include personal computers, laptop computers, notebook computers, palm top computers, network computers, Internet appliances, Internet kiosks, or any processor-controlled device capable of executing a web browser 56 or other type of application for interacting with the broadband content delivery system 10 or other content source. The user machines may also be kiosks or interactive kiosks that are typically presented in a retail environment. For example, an interactive kiosk that displays content provided by the branded channel can be presented in an aisle of a store that sells products or services of corresponding brand. Such an interactive kiosk may display content regarding the brand's products or services offered in the aisle in which the kiosk is located, providing moment-in-time marketing and allowing store customers to learn more about the brand's products or services. For example, a convenience store may have a kiosk that displays branded channels for such brands a Coke®, Frito-Lay® or any other brand of products that the convenience store sells. Likewise, a store may have its own branded channel that includes content about the products and services sold under the store's brand or other brands. The store may also display its branded channel on interactive kiosks and may offer available advertising times (“avails”) on the branded channels displayed on the kiosks to companies whose products or services are sold by the store.

The NOC 12, or other content source, may comprise one or more servers. FIG. 2B illustrates typical hardware components of a NOC or content source server 58. The branded channel may be implemented and delivered with one NOC or content source server 58 or with a NOC or content source servers 58. Other servers at the NOC 12, at the ISP 16, or other content source, may have similar or the same hardware components. The server 58 typically includes a memory 60, a secondary storage device 62, a processor 64, an input device 66, a display device 68, and an output device 70. The memory 60 may include RAM or similar types of memory, and it may store one or more applications 72 for execution by processor 64. The applications 72 may perform the methods (or portions thereof) described below.

The secondary storage device 62 may include a hard disk drive, floppy disk drive, CD-ROM drive, or other types of non-volatile data storage. The processor 64 executes applications 72, that are stored in memory 60 or secondary storage 62, or received from the Internet 26 or other network. The input device 66 may include any device for entering information into server 58, such as a keyboard, mouse, cursor-control device, touch-screen, infrared sensor, microphone, digital camera, video recorder or camcorder. The display device 68 may include any type of device for presenting visual information such as, for example, a computer monitor or flat-screen display. The output device 70 may include any type of device for presenting a hard copy of information, such as a printer, and other types of output devices include speakers or any device for providing information in audio form.

The server 58 may store a database structure in secondary storage 62, for example, for storing and maintaining information regarding the broadband content delivery system 10, the clients 18, and/or the branded channels. For example, it may maintain a relational or object-oriented database, or any other type of database, for storing information concerning users, the access rights of the users and their account status. Likewise, it may maintain a relational or object-oriented database, or any other type of database, for storing information concerning links between and among content provided on the branded channel and other content broadcast by the system.

As mentioned above, processor 46 and/or processor 64 may execute one or more software applications 44 or 72 in order to deliver and support the branded channel, methods, and other functions described in this specification. The processing may be implemented in software, such as software modules, for execution by computers or other machines.

The processing by processor 46 and/or processor 64 may provide and support pages, windows and menus (collectively, “screens”) described in this specification and otherwise for display on display devices associated with the client 18. The term “screen” refers to any visual element or combinations of visual elements for displaying information or forms; examples include, but are not limited to, graphical user interfaces on a display device or information displayed in web pages or in pop-up windows/menus on a display device. The screens may be formatted, for example, as web pages in HyperText Markup Language (HTML), Extensible Markup Language (XML) or in any other suitable form for presentation on a display device depending upon applications used by users to interact with the broadband content delivery system 10 or other content source.

Although only one server 58 is shown, broadband content delivery system 10 or other content source may use multiple servers 59 as necessary or desired to support the users and may also use back-up or redundant servers to prevent network downtime in the event of a failure of a particular server. In addition, although the user machine 40 and server 58 are depicted with various components, one skilled in the art will appreciate that the user machine 40 and the server 58 can contain additional or different components. In addition, although aspects of an implementation consistent with the present invention are described as being stored in memory, one skilled in the art will appreciate that these aspects, components or applications can also be stored on or read from other types of computer program products or computer-readable media, such as secondary storage devices, including hard disks, floppy disks, or CD-ROM; a carrier wave from the Internet or other network; or other forms of RAM or ROM. The computer-readable media may include instructions for controlling a computer system, such as user machine 40 and server 58, to perform a particular method or implementation, such as those described below.

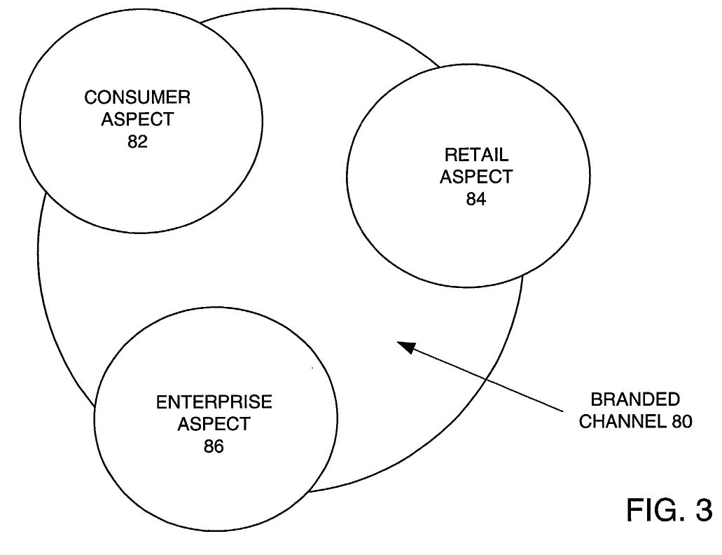

A branded channel typically delivers content that is relevant to a particular brand (or brands), corporation, association, organization, company or advertising mission (collectively, brand). For example, a Company X branded channel will deliver content that is relevant to Company X and the products and/or services that Company X provides. The branded channel may include co-branded content. As shown in FIG. 3, an embodiment of the branded channel 80 comprises three aspects, components, or applications (hereinafter, aspect): consumer 82, retail 84, and enterprise 86. Alternatively, a branded channel 80 only includes one or two of these aspects. In the consumer aspect 82, the branded channel 80 delivers relevant content to users in the consumer environment (e.g., consumers at homes, offices, or businesses). In the retail aspect 84, the branded channel 80 delivers relevant content to users in the retail environment (e.g., consumers, salespeople, or clerks at retail outlets, stores, etcetera). In the enterprise aspect 86, the branded channel 80 delivers relevant content to users in the enterprise environment (e.g., employees, store managers, or franchise owners). As described below, some branded channel 80 content may be live, similar to a live web-casts or video conferencing. Other branded channel 80 content may be forwarded and stored, at the NOC, the client or other location for immediate access and retrieval.

Related branded channels 80 may also be bundled together. Alternatively, a branded channel 80 may bundle together content from related brands. For example, branded channels 80 for an airline, a hotel, and a rental company may be bundled together. In this manner, the bundled branded channels 80 may be displayed together offering related branded channel 80 content (generally, retail aspect 84 or consumer aspect 82) for selection and viewing by a user. For example, a user at a client 18 (e.g., a kiosk or home computer) may choose to view travel-related branded channels 80 and be shown the bundled branded channels 80 of the airline, hotel and rental company. The user could then select to view content from each of the bundled branded channels 80 in order to view advertisements and accept offers for, e.g., an airline, hotel and rental car. This type of bundling between related companies may be referred to as “vertical bundling”. The vertically bundled branded channels 80 may include links (e.g., hyper-text mark-up language (HTML) hyperlinks) to each other.

Alternatively, a company may own or control multiple brands and may bundle together branded channels 80 for each of the companies brands. Alternatively, the company branded channel 80 may bundle together content from each of the company's brands. For example, Proctor & Gamble® may bundle together branded channels 80 for Ivory Soap® and Crest Toothpaste®, under the auspices of a Proctor & Gamble® branded channel 80. This type of bundling between a company's brands may be referred to as “horizontal bundling”. The horizontally bundled branded channels 80 may include links (e.g., hyper-text mark-up language (HTML) hyperlinks) to each other.

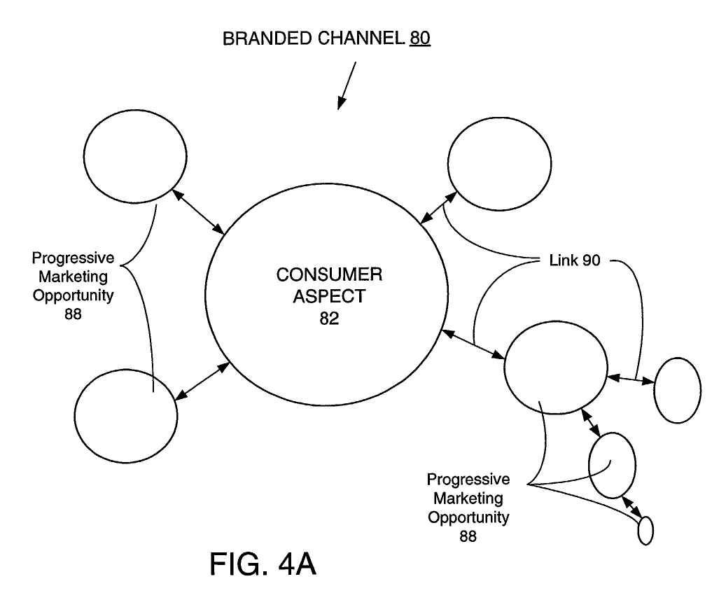

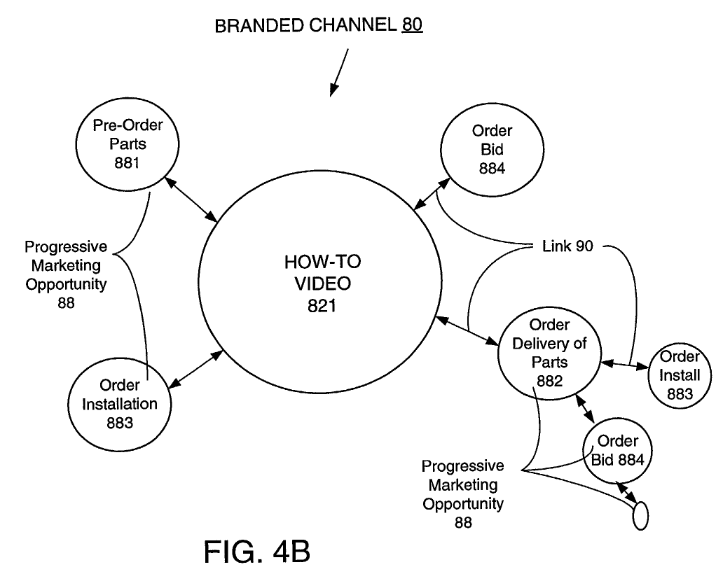

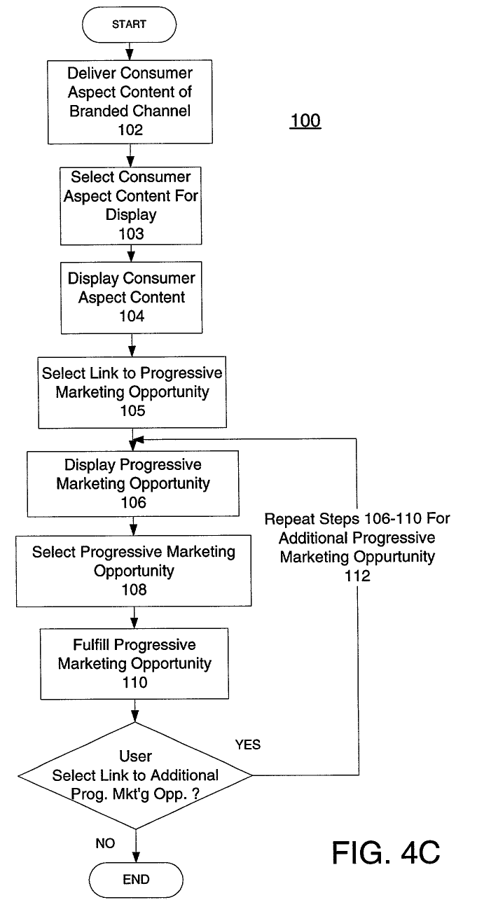

Referring now to FIG. 4A, the consumer aspect 82 of the branded channel 80 preferably includes and offers a wide variety of progressive marketing opportunities 88. Generally, the consumer aspect 82 of the branded channel 80 is delivered to clients 18 in consumer homes or businesses (e.g., an office supply company branded channel 80 may be broadcast to office managers). As illustrated by FIG. 4A, the consumer aspect 82 content may comprise content relevant to the brand with links 90 (e.g., hyper-text mark-up language (HTML) hyperlinks) to additional content, web pages, screens, web sites, coupons, premiums, rebates, discounts, samples, information, or options that represent progressive marketing opportunities 88 for the brand or other companies, available through the Internet 26 and/or delivered with the branded channel 80 content. The consumer aspect 82 content itself may include the coupons, rebates, discounts, premiums, samples, information, or options that represent progressive marketing opportunities 88 for the brand or other companies. The consumer aspect 82 content may be offered to the user for free or for a price.

Referring now to FIG. 4B, the consumer aspect 82 content may comprise a how-to video 821, for example. On a home-supply store branded channel 82, for example, the how-to video 821 may be a “how to install a toilet” video. This how-to video 821 may include links 90 to various progressive marketing opportunities 88. For example, the progressive marketing opportunities 88 may include electronic forms, screens, or web pages for pre-ordering the necessary parts 881 (and/or tools) for pickup at the nearest home-supply store, ordering delivery of the necessary parts 882 (and/or tools) to the user's home, ordering installation 883 of the toilet or ordering a bid 884 (or estimate) for a complete bathroom remodeling. The completed forms may be sent to the local brand outlet (e.g., the local home-supply store) or another brand-processing center at which the order is processed.

Each progressive marketing opportunity 88 represents an additional marketing opportunity that progresses from the initial content offered or marketing opportunity on the consumer aspect 82 of the home-supply store branded channel 80. In other words, as shown in FIG. 4B, the branded channel 80 preferably comprises consumer aspect 82 content that includes a plurality of progressive marketing opportunities 88, some progressive marketing opportunities 88 leading to other progressive marketing opportunities 88. For example, a user could view the how-to video 821, select ordering delivery of the necessary parts 882, and then select ordering installation 883 or ordering a bid 884.

Other examples of consumer aspect 82 content preferably include rich media catalogues providing, for example, video clips, still video, or audio clips regarding products and services (e.g., clothes, restaurants, electronics, furniture, or automobiles) that the brand offers. For example, an office-products store branded channel 80 may include a rich multimedia catalogue with video clips illustrating office furniture and equipment that it sells. The catalogue may include, for example, links to electronic forms for pre-ordering furniture, or equipment for purchase and pick-up, ordering delivery of purchased furniture or equipment, or ordering a bid from a furniture designer for custom made furniture. Likewise, a travel agency branded channel 80 may include rich media content regarding travel destinations or tours. For example, video, still video, and audio clips illustrating the sites and sounds of particular destinations may be included with links for making the travel arrangements. Also, a real estate agency branded channel 80 may include rich media content regarding specific real estate offered for sale. For example, video clips illustrating a house or an interactive video walk-through tour of a house both may have links for such things as arranging an in-person tour, contacting a realtor or placing a bid on the house. Likewise, a survey/research company branded channel 80 may include content regarding product or public opinion surveys. The consumer aspect 82 of the branded channel 80 preferably offers virtually limitless possibilities for the types of products, services, and brands that it can support and the related content that it displays.

Referring now to FIG. 4C, a method of providing a consumer aspect of a branded channel 100 is illustrated. The method 100 preferably comprises the steps of: delivering consumer aspect content of a branded channel 102; displaying the consumer aspect content 104; displaying a progressive marketing opportunity 106; selecting the progressive marketing opportunity 108; fulfilling the selected progressive marketing opportunity 110; and, if selected by a user, repeating steps 106-110 for additional progressive marketing opportunity 112. The consumer aspect 82 content is preferably delivered 102 via a broadband medium as described above and through known methods (e.g., via a virtual channel 22 of the delivery system 10 to a client 18). The consumer aspect 82 content preferably includes broadband or high-bandwidth content (e.g., 512 Kbps or more). If delivered to a client 18 or otherwise, the method 100 may further comprise the step of selecting the consumer aspect content for display 103. The selecting step 103 preferably includes a client 18 displaying a screen with selectable options for one or more branded channels 80, a user selecting one of the options (e.g., using an input device 48 such as a touch screen, keyboard, voice activated, or cursor-control) one of the branded channels 80, and the client 18 processing the selection. Alternatively, the selecting step 103 comprises the client 18 filtering one or more branded channels 80 and/or the content simultaneously provided by one or more branded channels 80 based on some criteria, such as user profiles, user preferences, or client 18 identity (e.g., whether the client 18 includes a home computer or a kiosk in a retail outlet) and selecting for display only the branded channel(s) 80 or branded channel 80 content that meets the criteria. In response to the user selection and client 18 processing, or the filtering and selecting, the client 18 preferably displays 104 the consumer aspect 82 content for the selected branded channel 80.

The consumer aspect 82 content may include a progressive marketing opportunity 88 or a link(s) 90 to one or more progressive marketing opportunity 88. Therefore, with reference to FIG. 4C, the method 100 may further comprise the step of selecting a link to a progressive marketing opportunity 105. The selecting step 105 preferably includes the client 18 displaying a screen with one or more links 90, the user selecting on of the links (e.g., using the input device 48), and the client 18 processing the selection. The screen with one or more links 90 may be displayed after the consumer aspect 82 content has been displayed for a certain period of time, for example, after a how-to video 821 has been displayed. The client 18 preferably displays 106 the progressive marketing opportunity 88 by executing the link using known methods.

The progressive marketing opportunity 88 preferably includes some offer that the user can accept. Selecting the progressive marketing opportunity 108, therefore, preferably includes the user accepting the offer (e.g., using the input device 48 to click an acceptance link or to complete and submit a form) and the client 18 processing the offer acceptance and communicating the offer acceptance to the content source server 58 or a server operated by the brand or a third-party, via the Internet 26 or other network. Ultimately, the acceptance is preferably communicated to whoever is responsible for fulfilling the selected progressive marketing opportunity 110, such as a local retail outlet of the brand, a third-party retail outlet, or an order processing center of the brand or third-party. The responsible party preferably performs the fulfilling step 110 by providing the products or services, for example, offered by the progressive marketing opportunity 88 and accepted by the user. For example, if the progressive marketing opportunity 88 offered pre-ordering of parts 881 for pick-up, a local retail outlet of the brand preferably gathers the ordered parts or tools and readies them for pick-up by placing them in bags and charging the user's credit card, if submitted.

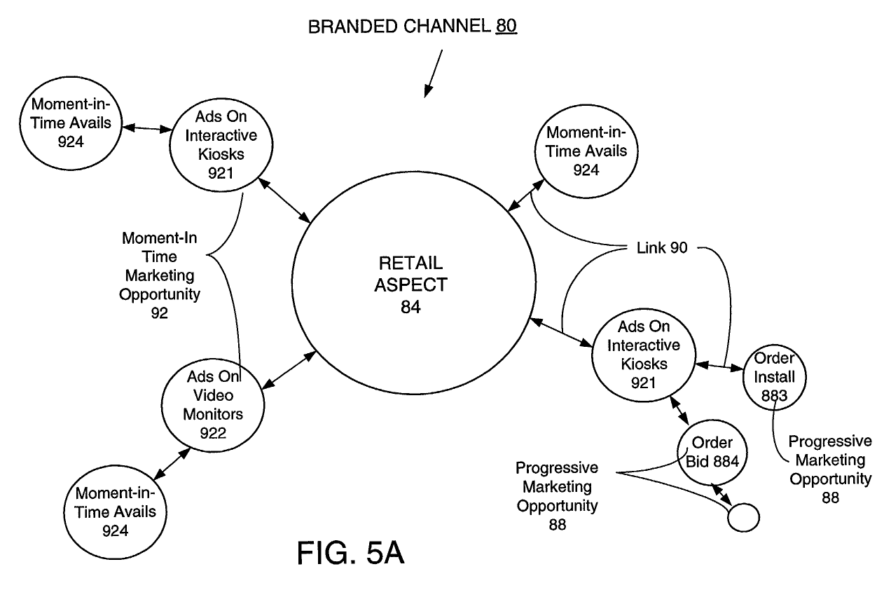

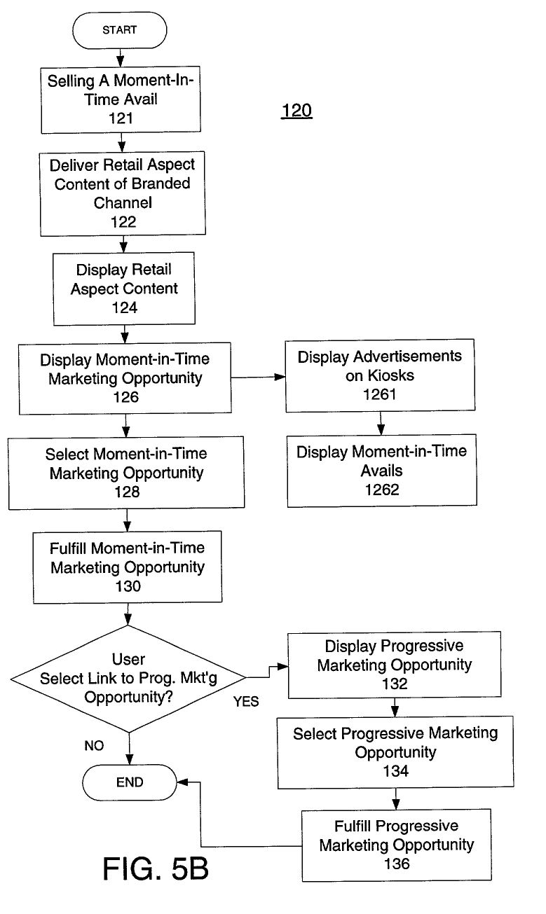

Referring now to FIG. 5A, the retail aspect 84 of the branded channel 80 offers a wide variety of content for display in a retail environment. The retail aspect 84 preferably includes moment-in-time marketing opportunities 92, such as advertisements displayed on interactive kiosks 921 or video monitors 922. Generally, the retail aspect 84 of the branded channel 80 is delivered to clients 18 in e.g., retail outlets, stores, or malls (collectively “retail outlets”) of the brand. A moment-in-time marketing opportunity 92 is, e.g, the brand or a third-party advertiser providing a shopper highly targeted marketing materials related to certain products or services at the moment-in-time that the shopper is “shopping” for those or related products or services. For example, a moment-in-time marketing opportunity 92 may include an advertisement for a brand of toothpaste displayed to a shopper in the toothpaste aisle of a grocery store.

Referring to FIG. 5A, the retail aspect 84 content preferably comprises, for example, advertisements, promotional material, coupons, premiums, discounts, samples, or infomercials (hereinafter, collectively “advertisements”) that represent moment-in-time marketing opportunities 92 for the brand or for companies whose products or services are sold in the retail outlets of the brand. For example, the retail aspect 84 of the branded channel 80 may be received and displayed by clients 18 comprising interactive kiosks or video monitors in retail outlets or wherever the brand has a presence. The moment-in-time marketing opportunity 92 may, therefore, include advertisements displayed on interactive kiosks 921 or advertisements displayed on video monitors 922. The interactive kiosk may comprise a display 50 and an input device 48 (e.g., keyboard, mouse, touch-screen, voice-activation) for retail outlet customers and employees to use.

The interactive kiosks may be located in aisles next to, or otherwise proximate, various types of products or services (e.g., paints, computers, lawnmowers, furniture, printers, gardening tools, or hardware). An interactive kiosk located in the paint aisle may display advertisements for a specific brand of paint, promoting the paint brand to the retail outlet customers who are specifically shopping for paint. In this manner, the retail aspect of the branded channel provides an unprecedented and lucrative moment-in-time marketing opportunity 92.

The advertisements 921 (or 922) may be content of the retail aspect 84 of a paint company branded channel 80 displayed on the retail outlets kiosks or video monitors. Alternatively, the branded channel 80 displayed on the interactive kiosk or video monitors may be the retail outlet's branded channel 80. Consequently, the advertisements 921 (or 922) may include moment-in-time avails 924 (i.e., advertising slots) that are sold by the company owning the branded channel 80 (e.g., the home-supply store brand). The branded channel owner may sell avails 924 for interactive kiosks or video monitors to various other companies (e.g., companies whose products or services are sold in the brand's retail outlets).

The avails 924 may be sold on a national or international retail aspect 84 of the branded channel 80 basis, for example, so that interactive kiosk(s) in appropriate location(s) (e.g., aisle(s) in which the company's products or services are sold) in every retail outlet of the brand receive and display the company's advertisement. Alternatively, the avails 924 may be sold on a regional or a local retail aspect 84 of the branded channel 80 basis so that only interactive kiosk(s) in appropriate location(s) in regional or local retail outlets of the brand receive and display the company's advertisement. Information delivered with the branded channel 80 (e.g., in a control channel or in packet headers of branded channel 80 content streams) enable clients 18 to filter the content so that only content intended for the client 18 is displayed. The avails 924 may be accessed by links 90, as described above, automatically displayed, or otherwise, and may be provided via the Internet 26 or delivered with the branded channel 80 content.

Referring again to FIG. 5A, the moment-in-time marketing opportunities 92 may include or provide progressive marketing opportunities 88, similar to those described above with regards to the consumer aspect 82. For example, if a retail outlet customer is viewing an advertisement or other content related to a specific product or service, such as paint, the retail aspect 84 of the branded channel 80 may provide links 90 to a progressive marketing opportunity 88 such as an advertisement or other content regarding a related product(s) or service(s), such as a power painting machine, paint brushes or wallpaper. The retail outlet customer may access progressive marketing opportunities 88, e.g., with the input device 48, such as with a touch screen input on the interactive kiosk display. In this manner, the brand may sell links 90 to progressive marketing opportunities 88 as additional moment-in-time avails 924.

Retail aspect 84 content may be displayed on interactive kiosks on a rotational basis. For example, the retail aspect 84 content may be displayed in a sequentially repeating, continuous basis. Likewise, as described above, retail aspect 84 content may be displayed as prompted by user selections communicated by an input device 48. For example, a customer in a paint aisle may select a link 90, for a type or brand of paint that is displayed on the screen of the interactive kiosk, in order to access content regarding the type or brand of paint. Typically, an interactive kiosk will display retail aspect 84 content on a rotational basis until a user selects a particular piece or retail aspect 84 content. If the kiosk is left idle for a set period of time, the kiosk may resume displaying the retail aspect 84 content on a rotational basis.

Another example of the retail aspect 84 content is a shopping mall branded channel 80. The shopping mall branded channel 80 may include content relevant to the mall and some or all of the stores within the mall. The shopping mall branded channel 80 may be displayed at kiosks, monitors or other clients 18 throughout the mall or within consumer homes. The shopping mall branded channel 80 content may include links to content provided by the stores or product brands sold at stores in the mall.

With reference now to FIG. 5B, a method of providing a retail aspect of a branded channel 120 is shown. The method 120 preferably comprises the steps of: delivering retail aspect content of a branded channel 122; displaying the retail aspect content 124; displaying moment-in-time marketing opportunities 126, which may include displaying advertisements on interactive kiosks 1261 and displaying moment-in-time avails 1262; selecting a moment-in-time marketing oppertunity 128; fulfilling the moment-in-time marketing opportunity 130; and, if selected, displaying a progressive marketing opportunity 132; selecting the progressive marketing opportunity 134; and, fulfilling the selected progressive marketing opportunity 136. Steps 132-136 are preferably performed as described above with respect to FIG. 4C. Likewise, as the method in FIG. 4C, the steps of the method 120 may be repeated based on user selection or a rotation or schedule of the retail aspect 84 content.

The retail aspect 84 content is preferably delivered 122 as described above and through known methods (e.g., via a virtual channel 22 of the delivery system 10 to a client 18). The retail aspect 84 content preferably includes broadband or high-bandwidth content (e.g., 512 Kbps or more). Preferably, the delivering step 122 delivers the retail aspect 84 content to an interactive kiosk or video monitor. In response to a user selection (not shown) or on a rotational, scheduled, or other basis, the client 18 (e.g., an interactive kiosk or video monitor) displays 124 the retail aspect 84 content. Alternatively, the method 120 may include filtering and selecting a branded channel(s) 80 or branded channel 80 content as described above with reference to FIG. 4C and the method 100.

As discussed above, the retail aspect 84 content may include moment-in-time marketing opportunities 92. Accordingly, an interactive kiosk or video monitor preferably performs the displaying step 126. The displaying step 126 may include displaying advertisements on interactive kiosks 1261 and displaying moment-in-time avails 1262. The moment-in-time avails 924 may be delivered with the branded channel 80 or separately via the Internet 26 or other network.

Referring to FIG. 5B, the moment-in-time marketing opportunity 92 may include some offer that the shopper can accept. Selecting the moment-in-time marketing opportunity 128, therefore, preferably includes the shopper accepting the offer (e.g., using the input device 48 to click an acceptance link) and the client 18 (e.g., the interactive kiosk) processing the offer acceptance. For example, if the moment-in-time marketing opportunity 92 was a coupon for a product, the interactive kiosk may fulfill the selected moment-in-time marketing opportunity 130 by printing out the coupon on an attached output device 52. Alternatively, processing the offer acceptance may include communicating the offer acceptance to a server operated by the brand or a third-party, via the Internet 26 or other network Ultimately, the acceptance is preferably communicated to whoever is responsible for fulfilling the selected moment-in-time marketing opportunity 130, such as the retail outlet in which the retail aspect 84 content is displayed. For example, the interactive kiosk may communicate the acceptance of a discount for a product to a check-out computer so that the check-out computer discounts the product when the shopper checks-out, thereby fulfilling the selected moment-in-time marketing opportunity 130.

As shown in FIG. 5B, the method 120 may also include selling a moment-in-time avail 121 to another company. If a moment-in-time avail 924 is sold (step 121) to a company, the company preferably provides advertisement(s) for inclusion with the retail aspect 84 content of the branded channel 80.

The enterprise aspect 86 of the branded channel 80 offers the brand enterprise-wide informational opportunities. Generally, the enterprise aspect 86 of the branded channel 80 is broadcast to clients 18 within the brand, such as employee, officer, and franchise owner or manager clients 18. Specifically, the enterprise aspect 86 content may comprise memorandums, directives, reports, or other content that is relevant to employees, officers, franchise owners or managers and other people related to the brand. For example, the president of Company X may issue a directive through the Company X branded channel to all Company X stores that requires the paint aisle to be relocated and reconfigured. The directive may include links to diagrams and video illustrating the new location and configuration of the paint aisle. Other enterprise aspect 86 content may include descriptions of new job openings, corporate performance reports, franchise performance reports, keynote speeches from company conferences, new commercials, new product descriptions, shareholder messages, motivational speeches and messages or any variety of similar content.

Another example of enterprise aspect 86 content includes delivering by the franchiser to all franchise owners, via the branded channel 80, of information about new products or services to be offered. This content may allow franchise owners to view information and purchase new inventory from the franchiser.

The enterprise aspect 86 of the branded channel may be used for live web-casts of company meetings, conferences or seminars. This may enable the brand to significantly reduce travel and other expenses normally incurred for such meetings and conferences. Likewise, the enterprise aspect 86, or other aspect, of the branded channel 80 may also offer the brand an opportunity to receive feedback from its customers, whether they are consumers or other companies. For example, a copier manufacturer may include surveys or forms on their branded channel for companies that have their copiers to provide feedback on their use of the copiers.

The clients 18 (e.g., the client software 43) preferably determines which aspects of the branded channel 80 to receive and display based, for example, on information (preferably contained within the program nuggets or packet headers) that describes the particular piece of content or on information (preferably contained within a stream header) that describes the content carried by a particular stream of the branded channel 80. The information may be a program type or program ID that identifies to which aspect or application (e.g., consumer aspect 82) of the branded channel 80 the content belongs. Content that belongs to different aspects of the branded channel 80 may be carried within the same stream of the branded channel 80. Alternatively, specific streams of the branded channel 80 may be devoted to one particular aspect of the branded channel 80 (e.g., one stream may be devoted to the retail aspect 84 of the branded channel 80, and therefore, may only be received or displayed by clients 18 within the retail environment, as described above).

Some content, however, may belong to more than one aspect of the branded channel 80. For example, some content may belong to both the consumer aspect 82 of the branded channel 80 and the retail aspect 84 of the branded channel 80. Such content may be delivered to and received and displayed by clients 18 within the consumer and retail environments, such as clients 18 in consumer homes and businesses and retail outlets, as described above. As a specific example with the home-supply store branded channel 80, the how-to-video may also be received and displayed by interactive kiosks within the home-supply stores. Customers shopping in a home-supply store may view a how-to-video at a kiosk in order to determine what parts, tools, etcetera that they need to purchase. The how-to-video displayed at the kiosks may have the same or similar progressive marketing opportunities 88 as described above. For example, the how-to-video at the kiosk may have a link 90 for ordering delivery of the parts and tools or for requesting a contractor to provide a bid for a complete remodeling.

Likewise, enterprise aspect 86 content may also belong to the retail aspect 84 of the branded channel 80. For example, content describing job openings or new products may be displayed on interactive kiosks or video monitors in the brand retail outlets. The brand may decide to which aspect or aspects of the branded channel 80 that the content belongs, including when content belongs to more than one aspect of the branded channel.

In a similar manner, the branded channel 80 content may be targeted to specific users based on stored user profiles, preferences and other information. The client 18 may store user profiles, e.g., on the secondary storage device 44, with user characteristics and preferences and may select branded channel 80 content based on the user profile. For example, a Ford® branded channel 80 may include content such as three 20-minute videos advertising Ford trucks, minivans, and sports cars. The client 18 may have three users, a Mom, Dad and a teenage Son, and may store separate user profiles for each user. Based on the user profiles, and the user characteristics and/or preferences contained therein, the client 18 may display or offer to display the truck video to Mom, the minivan video to Dad, and the sports car video to the teenage Son. Any aspect, consumer 82, retail 84, or enterprise 86 may be targeted to users in this manner. A client 18 may only display branded channel 80 content to a user whose user profile meets criteria of the branded channel 80 content. See the related U.S. Patent Application entitled “Personal Content Manager”, incorporated above, for a further description of content personalization and targeting.

As mentioned above, consumer aspect 82 content may be offered for free or for a price. For example, the how-to video described above may be offered for viewing for $.75 or downloading and viewing for $1.00. As described in the related U.S. Patent Application entitled “Credit System”, incorporated above, a credit system may be provided that enables users to purchase content with credits and to earn additional credits, among other things. As such, users wanting to view consumer aspect 82 content may purchase this content by having credits debited from their credit account.

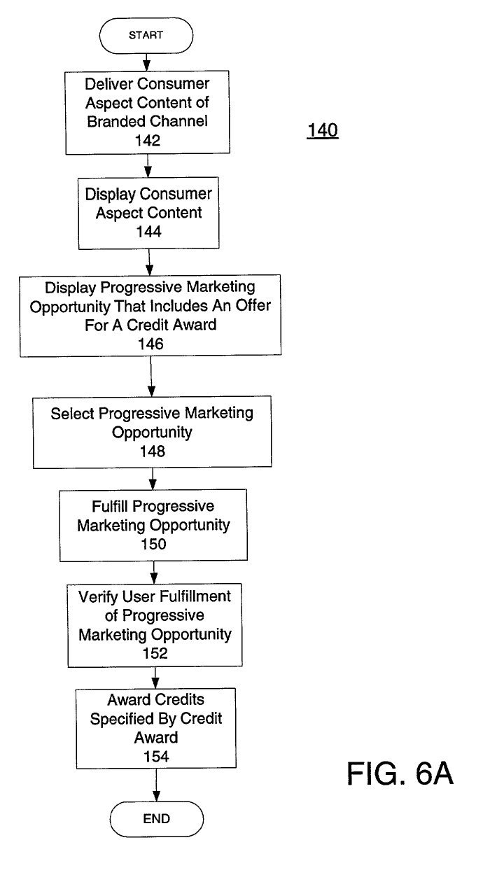

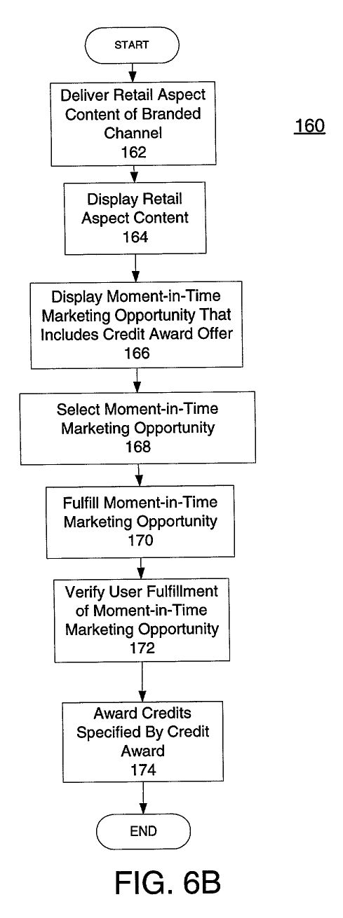

Likewise, opportunities to earn credits may be offered by a branded channel 80, as illustrated by FIGS. 6A and 6B. These opportunities may be offered by any of the aspects of the branded channel 80. For example, opportunities to earn credits may be tied into the progressive marketing opportunities 88 provided by the consumer aspect 82 content. Using the how-to video example, the pickup, delivery, installation and bid options may each include offers for credit awards. If the user selects one of these options, the user may earn the associated credit award. In other words, the credit awards may be used to entice the user to select one of the options. Typically, greater credit awards may be offered for the more profitable options. If the installation option were the most profitable, the associated credit award may be the largest.

Referring to FIG. 6A, a method of providing a consumer aspect of a branded channel with credit awards 140 is illustrated. The method 140 is similar to the method 100 described above with reference to FIG. 4C, with the addition of verification of user fulfillment of the credit award conditions and awarding credits to the user. Accordingly, the method 140 preferably comprises the steps of: delivering consumer aspect content of a branded channel 142; displaying the consumer aspect content 144; displaying a progressive marketing opportunity including an offer for a credit award 146; selecting the progressive marketing opportunity 148; fulfilling the selected progressive marketing opportunity 150; verifying user fulfillment of the progressive marketing opportunity 152; and, awarding credits specified by the credit award 154. The verification step 152 preferably comprises verifying that the user performed necessary steps with regard to the selected progressive marketing opportunity 88. Generally, this includes verifying that the user paid for the products or services offered by the selected progressive marketing opportunity 88. Verification and awarding the credits 154 may be performed as described in the “Credit System” application.

Credit awards may also be offered through the retail aspect 84 of the branded channel 80. For example, moment-in-time marketing opportunities 92 displayed by interactive kiosks may offer credit awards for the purchase of their products or services. Likewise, progressive marketing opportunities 88 provided by the retail aspect 82 content may include credit award offers. Referring to FIG. 6B, a method of providing a retail aspect of a branded channel with credit awards 160 is illustrated. The method 160 is similar to the method 120 described above with reference to FIG. 5B, with the addition of verification of user fulfillment of the credit award conditions and awarding credits to the user. Accordingly, the method 160 preferably comprises the steps of: delivering retail aspect content of a branded channel 162; displaying the retail aspect content 164; displaying moment-in-time marketing opportunity including credit award offer 166; selecting a moment-in-time marketing opportunity with a credit award offer 168; fulfilling the moment-in-time marketing opportunity 170; verifying user fulfillment of the moment-in-time marketing opportunity 172; and, awarding credits specified by the credit award 174. The verification step 172 preferably comprises verifying that the user performed necessary steps with regard to the selected moment-in-time marketing opportunity 92. Generally, this includes verifying that the user paid for the products or services offered by the selected moment-in-time marketing opportunity 92. Verification and awarding the credits 174 may be performed as described in the “Credit System” application.

Similarly, the enterprise aspect 86 content may offer credit awards to employees or others in reward for good job performance, safety records, or business development, for example. In sum, the credit award offers may be used to provide incentive for use of the branded channel 80 and as a promotional tool for products or services offered by the brand and other companies. The credits for the credit awards may be transferred from accounts maintained by the brand or the other companies providing content on the branded channel 80 or otherwise debited from the brand or the other companies.

While the invention has been described with reference to the exemplary embodiments thereof, those skilled in the art will be able to make various modifications to the described embodiments of the invention without departing from the true spirit and scope of the invention. The terms and descriptions used herein are set forth by way of illustration only and are not meant as limitations. Those skilled in the art will recognize that these and other variations are possible within the spirit and scope of the invention as defined in the following claims and their equivalents.

What is claimed is:

1. A method of providing a branded channel, wherein the branded channel is associated with a brand and the branded channel includes branded channel content that is relevant or related to the brand, the method comprising the steps of:
delivering the branded channel via a communication medium;
displaying the branded channel content, whereby the displaying step displays branded channel content that is associated with other content, the other content including a first progressive marketing opportunity; and
displaying the first progressive marketing opportunity, wherein the first progressive marketing opportunity is a marketing opportunity that is related to the displayed branded channel content.

2. The method of claim 1, wherein the branded channel content includes high bandwidth content.

3. The method of claim 1, further comprising the step of:
selecting the branded channel content for display, whereby displaying the branded channel content step displays the branded channel content based on the selecting step.

4. The method of claim 3, wherein the selecting step includes receiving a user selection of the branded channel.

5. The method of claim 3, wherein the selecting step includes a client filtering the branded channel content.

6. The method of claim 1, wherein the first progressive marketing opportunity includes an offer of a product or service, the method further comprising the steps of:
receiving a selection of the first progressive marketing opportunity, whereby the offer is accepted; and
fulfilling the first progressive marketing opportunity, whereby the product or service is provided.

7. The method of claim 6, further comprising the step of:
repeating the displaying step, receiving step, and fulfilling step for a second progressive marketing opportunity.

8. The method of claim 1, wherein the delivering step delivers the branded channel via a broadband medium.

9. The method of claim 1, wherein the displaying the branded channel content step includes displaying bundled branded channels of a plurality of related brands.

10. The method of claim 1, wherein the displaying the branded channel content step includes displaying bundled branded channel content of a plurality of related brands.

11. The method of claim 1, wherein the displaying the branded channel content step includes displaying a second progressive marketing opportunity.

12. The method of claim 1, wherein the displaying the branded channel content step includes displaying a how-to video.

13. The method of claim 1, wherein the displaying the first progressive marketing opportunity step includes displaying an offer to order installation of a product.

14. The method of claim 1, wherein the displaying the first progressive marketing opportunity step includes displaying an offer to order parts for delivery.

15. The method of claim 1, wherein the displaying the branded channel content step includes displaying consumer aspect content.

16. The method of claim 15, wherein the displaying the branded channel content step displays the consumer aspect content on a client computer in a user home.

17. The method of claim 15, wherein the displaying the branded channel content step displays the consumer aspect content on an interactive kiosk in a retail outlet.

18. The method of claim 1, wherein the displaying the branded channel content step includes displaying retail aspect content.

19. The method of claim 18, wherein the displaying the branded channel content step displays the retail aspect content on a client computer in a user home.

20. The method of claim 18, wherein the displaying the branded channel content step displays the retail aspect content on an interactive kiosk in a retail outlet.

21. The method of claim 18, further comprising the steps of:
displaying a moment-in-time marketing opportunity, wherein the moment-in-time marketing opportunity includes an offer related to a product or service;
receiving a selection of the moment-in-time marketing opportunity, whereby the offer is accepted; and,
fulfilling the moment-in-time marketing opportunity, whereby the product or service is provided.

22. The method of claim 21, wherein displaying the moment-in-time marketing opportunity step further includes displaying a credit award offer that specifies a number of credits that are awarded if the product or service offer is selected and fulfilled, the method further comprising:
verifying fulfillment of the moment-in-time marketing opportunity; and
awarding the credits specified in the credit award offer, wherein the credits may be used to purchase content.

23. The method of claim 18, wherein the displaying the retail aspect content step includes displaying one or more moment-in-time avails, the method further comprising the step of:
selling a moment-in-time avail to an advertiser so that the advertiser can provide an advertisement for inclusion on the branded channel.

24. The method of claim 1, wherein the displaying the branded channel content step includes displaying content selected from the group consisting of: consumer aspect content, retail aspect content and enterprise aspect content.

25. The method of claim 1, wherein the displaying the first progressive marketing opportunity step includes displaying an electronic form for use in ordering a product or service, the method further comprising the steps of:
transmitting the electronic form to a brand-processing center for processing, wherein the transmitted electronic form includes entered data related to ordering the product or service.

26. The method of claim 25, wherein the electronic form includes data fields for entering information in exchange for credits rewarded to a user's credit account, the method further comprising the step of:
adding credits to the user's credit account.

27. A branded channel associated with a brand, wherein the branded channel is delivered via a communication medium, the branded channel comprising:
branded channel content relevant to the brand, wherein the branded channel content is displayed by a client computer on a display device; and
progressive marketing opportunities, wherein the progressive marketing opportunities:
are related to the branded channel content;
include offers for products or services of the brand; and
can be selected by a user of the client computer.

28. The branded channel of claim 27, further comprising:
links to other content, wherein the links are displayed with the branded channel content and may be selected by the user of the client computer to access the progressive marketing opportunities.

29. The branded channel of claim 27, wherein the client computer is an interactive kiosk in a retail outlet.

30. The branded channel of claim 29, further comprising:
moment-in-time marketing opportunities, wherein the moment-in-time marketing opportunities include an advertisement related to product sold in the retail outlet and the advertisement is displayed on the interactive kiosk in an aisle in which the product is offered for sale.

31. A method of placing avails in a retail outlet, comprising the steps of:
delivering a branded channel to a client in a retail outlet, wherein the branded channel includes branded channel content;
locating the client in a particular location of the retail outlet, wherein the particular location contains related products; and
displaying the branded channel content on the client in the particular location, wherein the branded channel content includes content relevant to one or more of the related products in the particular location.

32. The method of claim 31, wherein the delivering step includes using an interactive kiosk that facilitates user interaction with the branded channel.

33. The method of claim 32, further comprising the step of selling moment-in-time avails to companies whose products are contained in the aisle.

34. An interactive kiosk, comprising:
a display that displays a branded channel, wherein the branded channel comprises branded channel content relevant to products displayed proximate the interactive kiosk;
an input device that enables a user to enter data;
a broadband connection, that enables the interactive kiosk to receive broadband content; and
a processor, that processes instructions to display specific content and to transmit data entered into with the input device.

35. A method of providing a branded channel, wherein the branded channel is associated with a brand and the branded channel includes only branded channel content that is relevant or related to the brand, the method comprising the steps of:
delivering the branded channel via a communication medium to a location in a retail outlet, wherein the branded channel content includes retail aspect content;
displaying the retail aspect content, wherein the retail aspect content includes moment-in-time marketing opportunities; and,
displaying the moment-in-time marketing opportunities, wherein the moment-in-time marketing opportunities are related to products or services offered for sale at the location in the retail outlet.

36. The method of claim 35, wherein the moment-in-time marketing opportunity includes an offer of a product or service, the method further comprising the steps of:
receiving a selection of the moment-in-time marketing opportunity, whereby the offer is accepted; and,
fulfilling the moment-in-time marketing opportunity, whereby the product or service is provided.

37. The method of claim 35, wherein the displaying the moment-in-time marketing opportunities includes the step of:
displaying advertisements on an interactive kiosk at the location in the retail outlet.

38. The method of claim 37, wherein the displaying advertisements on an interactive kiosk step includes the step of:
displaying moment-in-time avails.

39. The method of claim 38, further comprising the step of:
selling a moment-in-time avail.

40. The method of claim 34, wherein the displaying the retail aspect content step displays branded channel content with links to other content, the other content including a progressive marketing opportunity, the method further comprising the steps of::
displaying the first progressive marketing opportunity, wherein the first progressive marketing opportunity is a marketing opportunity that is related to the displayed retail aspect content and the first progressive marketing opportunity includes an offer of a product or service;
receiving a selection of the progressive marketing opportunity, whereby the offer is accepted; and
fulfilling the progressive marketing opportunity, whereby the product or service is provided.
